(19) United States
(12) Patent Application Publication
(10) Pub. No.: US 2002/0191609 A1
(43) Pub. Date: Dec. 19, 2002

(54) Computer assisted measuring device

(76) Inventor: Robert F. Exman, Woodstock, OH (US)

Correspondence Address: Richard C. Litman, LITMAN LAW OFFICES, LTD., P.O. Box 15035, Arlington, VA, 22215, US

(21) Appl. No.: 09/883,223

(22) Filed: Jun. 19, 2001

(51) Int. Cl. H04L 12/56; G01B 3/12; G01B 5/26

(52) U.S. Cl. 370/390; 33/773; 33/124; 370/386

(57) ABSTRACT

A computer assisted measuring device that can be tied into a computer to generate price quotes and measurements for the carpet cleaning industry. The device is made up of a measuring wheel, which is used to roll on a surface being measured, a shaft, which attaches the measuring wheel to the end of the computer assisted measuring device, a control box casing, which houses computer compartment components and battery compartment components, a handle for ease of handling and a computer interface jack for connecting the computer assisted measuring device to a computer.

The invention includes program software and utilizes photoelectric technology to determine the distance being measured by the device.

### BACKGROUND OF THE INVENTION

1. Field of the Invention

The present invention relates to a computer assisted measuring device. More particularly, the invention is a computer assisted measuring wheel that can be tied into a computer to generate sales quotes and measurements for the carpet cleaning industry.

2. Description of the Related Art

Computer software can be applied to an unlimited number of situations to perform basic calculations and generate a professional price quote or proposal. The software can receive measured quantities from a piece of equipment, such as a measuring wheel, and incorporate those measured quantities into calculations such as square footage and costs per square foot expenses.

U.S. Pat. No. 3,696,510 issued to Evans, Jr., outlines the use of a measuring wheel, wherein a rotatable wheel is mounted upon a conical recessed hub and a counter mechanism is secured to the wheel and extends within the recessed hub. The counter mechanism is adapted to record the rotational movement of the wheel and a tubular handle is secured to the counter mechanism by an attaching bracket, with the bracket being relieved to not interfere with the surface being measured and the handle being outwardly curved adjacent to the bracket.

U.S. Pat. No. 4,967,484 issued to Nosek, outlines a method and apparatus for measuring distances selectively along any one or more of an outwardly facing subadjacent surface, such as a floor surface, a horizontally facing surface, such as a wall surface, and a downwardly facing surface, such as a ceiling surface. The measurement is effected by utilizing an extendible mounting member carrying, at one end, a measurement wheel and an associated counter adapted to be viewed by a person utilizing the device and grasping the opposite end of the mounting member in effecting a rolling movement of the wheel along the surface to be measured.

U.S. Pat. No. 4,970,802 issued to Nosek, outlines the use of a measured wheel device having selectively usable and positionable hub elements for use with a plurality of different measuring wheels and corresponding gearing for utilization of a counter to provide different readouts in effecting desired measurements. The hub elements are received in a recess in the housing of the measuring device and are retained as a result of securing together of separate portions of the housing of the measuring device.

U.S. Pat. No. 5,052,687 issued to Katerba, outlines the use of a golf flagstick with an attached digital odometer, where the odometer is placed at the top of the flagstick. When the distance between a golf ball and a hole is to be determined, the flagstick is removed from the hole, turned upside down and wheeled between the golf ball and the hole. As the wheel of the odometer is rolled along the green, the distance is recorded and displayed by a digital display. A writing pad can also be attached to the flagstick so that scores, distances and other appropriate data can be recorded.

U.S. Pat. No. 5,148,411 issued to Shalvi, outlines the use of a distance measuring device including a casing bearing a visual display and incorporating a transmitter for directing signals toward a selected surface, a receiver for detecting echoes from the selected surface, distance calculating circuitry for measuring the distance to a selected surface in accordance with the transit time of the signal and visually displaying the calculated distance. Memory is also provided for storing at least two displayed distances measured in perpendicular directions, as well as multiplication circuitry for multiplying the stored measurements and visually displaying the product of the multiplication.

U.S. Pat. No. 5,161,313 issued to Rijlaarsadam, outlines the use of a hand-held instrument for measuring and calculating length, area, peripheries and volume is disclosed. The instrument has a housing with a tapered end giving it the overall appearance of a writing instrument. The instrument has a tracking wheel which follows a line or curve through a revolution of the wheel. The wheel revolutions are then transmitted via an apertured shaft to an opto-electronic device which reads the angular position of the shaft and converts the wheel revolutions into electrical pulses. The pulses are inputed into a calculator which calculates length, surface area, peripheries and volume.

U.S. Pat. No. 5,780,846 issued to Angilella et al., outlines the use of a measuring device which includes a measuring head with a movable body designed to be placed in contact with an object on which the measurement is to be executed. The device includes structure for the generation of electromagnetic radiation and conveying structure to convey the electromagnetic radiation to the movable body. The movable body has a plurality of markings which modulate the electromagnetic radiation in relation to movement of the movable body.

U.S. Pat. No. 5,893,082 issued to McCormick, outlines the use of a computer system for processing and presenting cost estimates in the construction industry. The system includes a CPU, primary input hardware for entering data and commands to the CPU, output hardware including a display for displaying information, estimating hardware for interacting with a plan print to count and scale off measurements of assemblies and items on the plan print and input such counts and measurements into the CPU for processing, as well as a memory unit having a database and software means.

U.S. Pat. No. 5,943,785 issued to Kondo, outlines the use of a curve length measuring apparatus that includes a pen holder-like body, a caster rotatably connected with the body so as to rotate around a rotation axis and having a disk including slits, a light emitting device, a light detecting device and an indicator. When the disk rolls on a curved line, the slits provided on the disk cross the beam of light emitted from the light emitting device so as to generate pulses. The light detecting device counts the number of these pulses and the indicator displays a length of the curve based on the number of detected pulses.

Although each of the devices described in the previous patents are useful devices, none can incorporate a measuring device with computer software to calculate a price quote for a carpet cleaning customer. That is what is needed, a measuring device that can measure the square footage of a measured area and incorporate various cost factors into a generated price quote for a carpet cleaning customer.

None of the above inventions and patents, taken either singularly or in combination, is seen to describe the instant invention as claimed. Thus a computer assisted measuring device solving the aforementioned problems is desired.

### SUMMARY OF THE INVENTION

The invention is a computer assisted measuring device that can be tied into a computer to generate price quotes and measurements for the carpet cleaning industry. The device is made up of a measuring wheel, which is used to roll on a surface being measured, a shaft, which attaches the measuring wheel to the end of the computer assisted measuring device, a control box casing, which houses computer compartment components and battery compartment components, a handle for ease of handling and a computer interface jack for connecting the computer assisted measuring device to a computer. The invention includes program software and utilizes photoelectric technology to determine the distance being measured by the device.

Accordingly, it is a principal object of the invention to generate professional sales quotes for carpet cleaning projects.

It is another object of the invention to easily measure the measurements of a carpet cleaning project.

It is a further object of the invention to reduce the amount of time spent on generating carpet cleaning sales quotes.

Still another object of the invention is to increase the total number of carpet cleaning sales quotes that a person can do in a regular working day, which will increase sales, provide more jobs and help the overall economy.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a computer assisted measuring device according to the present invention.

FIG. 2 is a perspective side view of a computer assisted measuring device according to the present invention.

FIG. 3 is a perspective view of photoelectric components of a computer assisted measuring device according to the present invention.

FIG. 4 is a perspective view of a circumference wheel of a computer assisted measuring device according to the present invention.

FIG. 5 is a top perspective view of a keypad and display unit of a computer assisted measuring device according to the present invention.

FIG. 6 is an electrical diagram of a computer assisted measuring device according to the present invention.

FIG. 7 is a sample price quote from a computer assisted measuring device according to the present invention.

Similar reference characters denote corresponding features consistently throughout the attached drawings.

### DETAILED DESCRIPTION OF THE PREFERRED EMBODIMENT

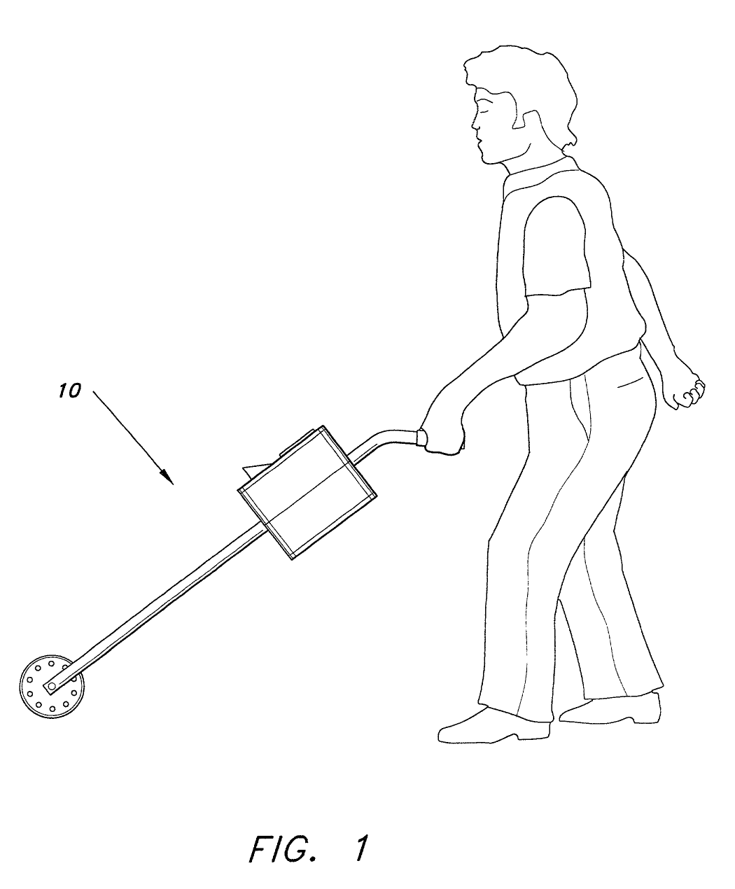

The present invention is a computer assisted measuring device 10. More particularly, the invention is a computer assisted measuring wheel that can be tied into a computer to generate price quotes and measurements for the carpet cleaning industry. Wherever measurements are made for quoting purposes, the computer assisted measuring device 10 can reduce the amount of time spent to do this and generate a professional looking sales quote. The computer assisted measuring device 10 is depicted in FIG. 1.

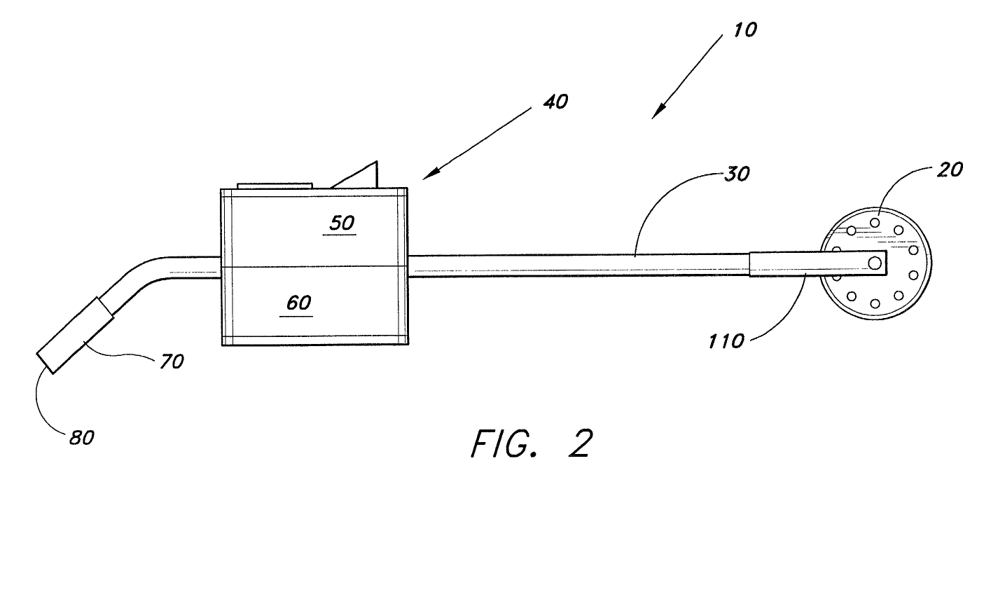

The computer assisted measuring device 10 is comprised of a measuring wheel 20, which is used to roll on a surface being measured, a shaft 30, which attaches the measuring wheel 20 attached to the end the computer assisted measuring device 10, a control box casing 40, which houses computer compartment components 50 and battery compartment components 60, a handle 70 for ease of handling and a computer interface jack 80 for connection to a computer via RS 232 cable. These features of the computer assisted measuring device 10 are illustrated in FIG. 2.

The computer assisted measuring device 10 is not just a measuring device. It stores an 8 bit code, with 256 possible combinations that describe what is being measured. The computer assisted measuring device 10 measures linear feet within one tenth of a foot. A two digit description code is entered into the computer assisted measuring device 10 before any measurements are taken.

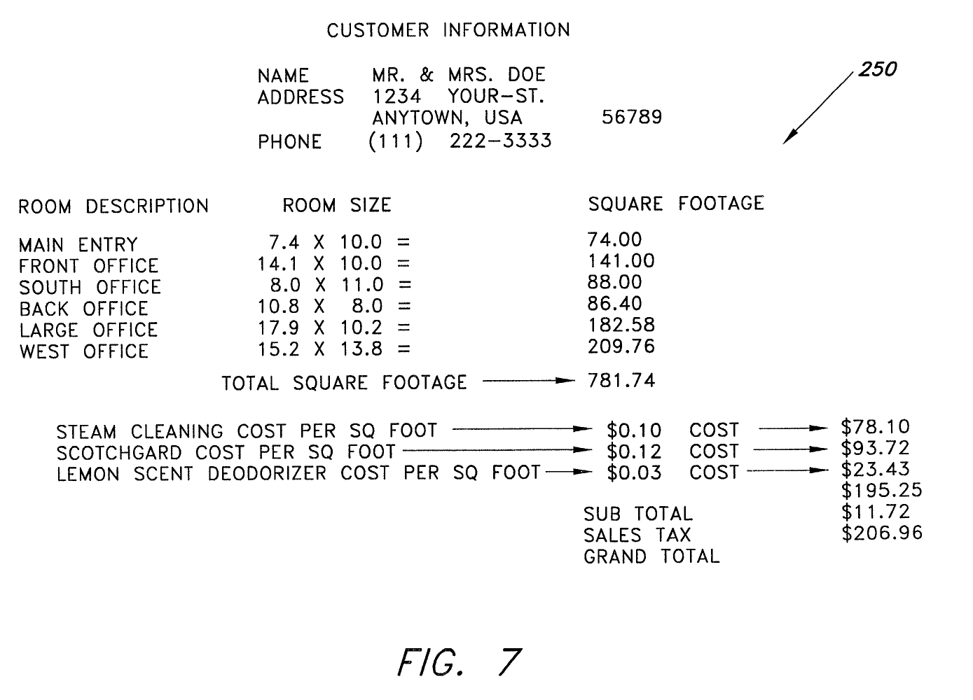

The description code can customize the description of a room for a more professional looking sales quote. The sales quote also indicates any measurements taken and corresponding math calculations. A sample sales quote is depicted on FIG. 7 in addition to more information on the sample sales quote.

Within the lower end of the shaft 30 near the end of the measuring wheel 20, additional components are housed. These include a shaft 90 and ball bearing 100 for movably securing the measuring wheel 20 to the shaft 30. A plastic PVC housing 110 is situated over the end of the shaft 30, that provides additional protection to these additional components.

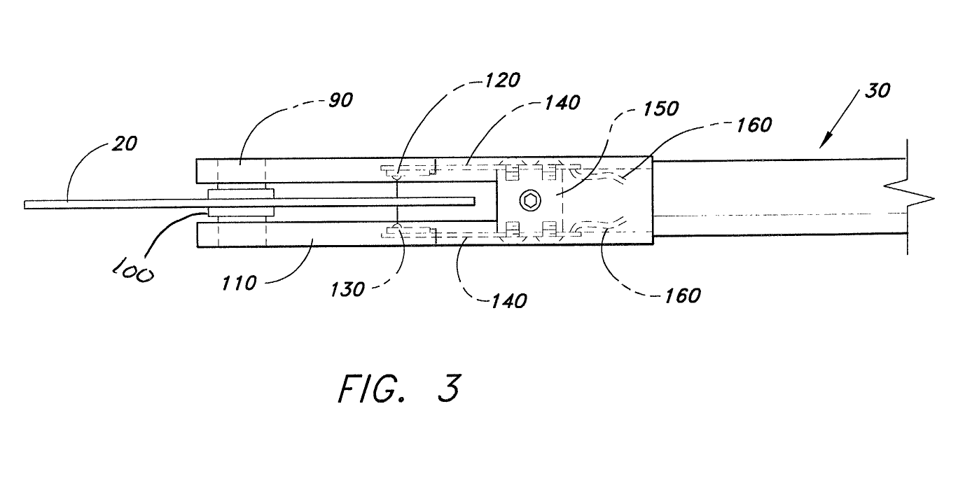

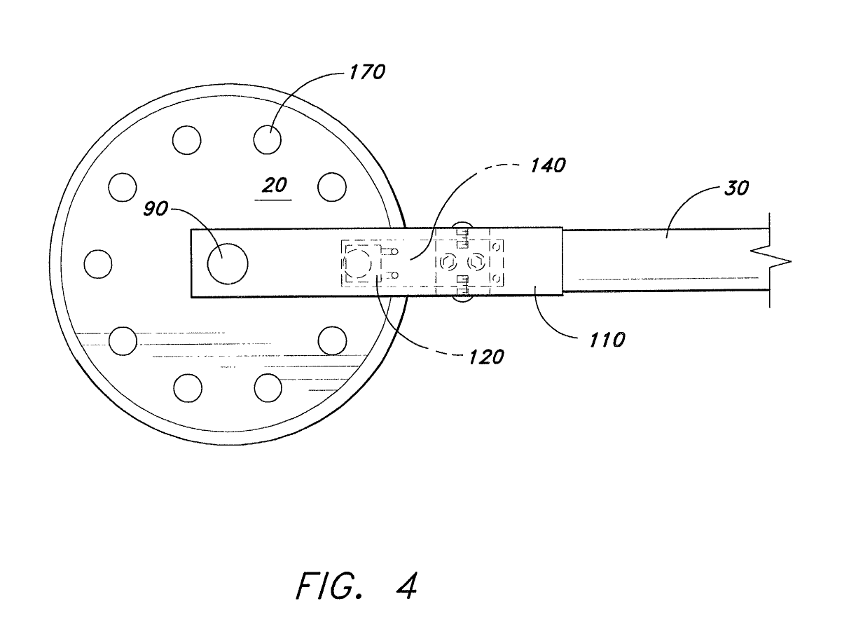

An infrared emitter 120 shoots a ray of infrared light through a plurality of holes 170 (FIG. 4) provided on the measuring wheel 20. Once passed through the measuring wheel 20, the infrared light is received by a phototransistor 130. The infrared emitter 120 and phototransistor 130 are attached to a pair of PC boards 140, which in turn is attached to a mounting block 150 that is secured to the plastic PVC housing 110. Wires 160 extend from the PC boards 140 up into the shaft 30 to the control box casing 40. These components are illustrated in FIG. 3 and FIG. 4.

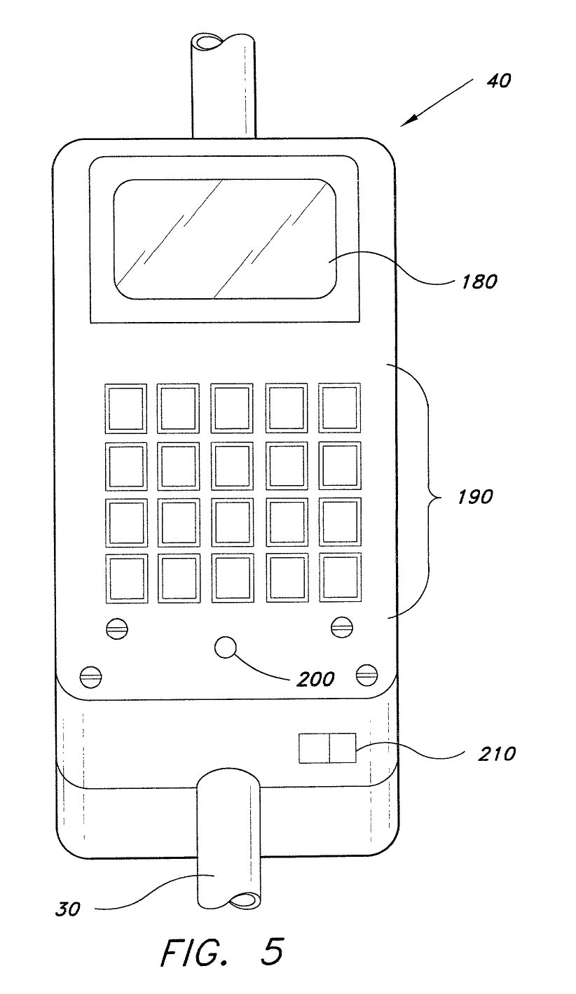

FIG. 5 illustrates the top of the control box casing 40, which shows a LCD display 180 and keypad 190. The computer assisted measuring device 10 can store up to 100 room dimensions that describe each room. The key pad 190 has 20 keys, 16 of which are for room codes and 4 command keys. The 4 command keys are “send”, which transfers data to a base computer, “view”, which allows a user to view a room code and its measurements, “clear”, which allows a user to remove a room code and its measurements and “enter”, which allows a user to enter a room code and its measurements into the computer assisted measuring device 10. There is also a reset button 200 and an on and off switch 210 on the computer assisted measuring device 10.

The user of the computer assisted measuring device 10 should enter a two digit room code that best describes the room that is about to be measured. The first digit corresponds to a general description of a measured room. There are 16 possible entries, which include 1 for a Cashier, 2 for a Main area, 3 for a North area, 4 for a South area, 5 for an East area, 6 for a Waiting Room area, 7 for a Lobby area, 8 for a Back area, 9 for an Upstairs area, A for a Downstairs area, B for a Large area, C for a Small area, D for a Presidents' area, E for a Vice Presidents' area and F for a prompt for entering any “Other” descriptive information.

The second digit corresponds to a more specific description of a measured room. There are also 16 possible entries, which include 1 for a Hall, 2 for an Office, 3 for Steps, 4 for a Bathroom, 5 for a Showroom, 6 for a Waiting room, 7 for a Lobby, 8 for a Lounge, 9 for an Entry area, A for a Kitchen area, B for a Bedroom area, C for a Dining room area, D for a Living room area, E for a Meeting room area and F for Other Room areas.

A user can enter this information to precisely describe a room that is being measured. The number of rooms and the corresponding room codes are displayed on a LCD display 180. After a room code is entered, measurements are made with the computer assisted measuring device 10, where the measuring wheel 20 is rolled from wall to wall, with the distances measured being displayed on the LCD display 180, within a maximum distance of 999.9 feet.

The user enters the first measurement by pushing the “Enter” button and any additional measurements that are at a right angle to the first measurement. This should accommodate any sized room that is square, rectangular, L-shaped or triangular. It can also calculate the square footage for a wall or a ceiling as well. The computer assisted measuring device 10 can hold up to 100 room codes and their measurements.

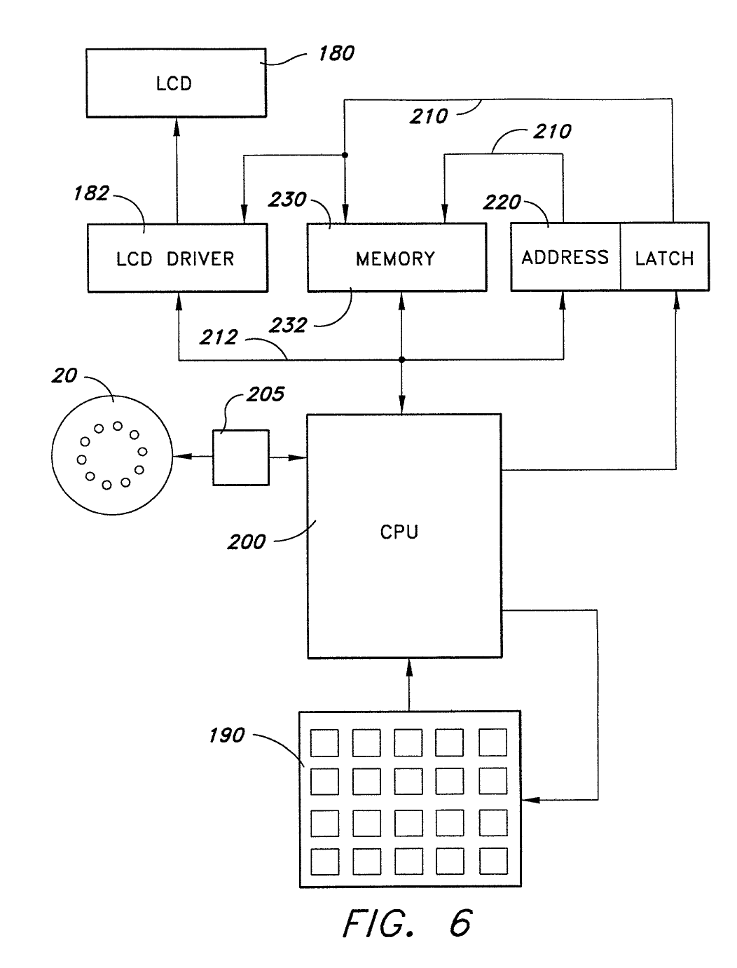

FIG. 6 outlines a basic electrical diagram of the computer assisted measuring device 10. The diagram includes a 20 key keypad 190, an LCD display 180, a LCD driver 182, an address bus 210, an address latch 220, 1 kilobyte of read only memory (ROM) 230, 64 bytes of random access memory RAM 232, a data bus 212, a central processing unit (CPU) 200, a voltage comparator 205, the measuring wheel 20 and a keypad 190. There is also a voltage comparator 230 between the CPU 200 and the measuring wheel 20, in the computer assisted measuring device 10.

After a user has entered all of the room codes and measurements, he or she runs the program software 240 that is provided with the computer assisted measuring device 10. At this point, the computer assisted measurement device 10 is connected (via RS 232 cable or infrared link) to a computer that the program software 240 has been downloaded onto. This computer must be a 286 or higher in order to have the capability to handle these measurements and calculations.

The software program 240 prompts the user to enter basic information about the customer such as the name, address, city, state, zip code, phone number, fax number and e-mail address of the customer. Other information such as the sales tax rate, cleaning per square foot rate, Scotchgard rate per square foot, deodorizer rate per square foot and other rates of services offered (up to 10 additional service rates) may be stored in the software program 240.

After the customer's information has been entered, a sales quote 250 can be generated from a printer tied into the computer being used. If the computer has a modem or Internet access, the sales quote can even be e-mailed or faxed to a customer. E-mail and fax technologies are well-known to those that are schooled in the related art and are not points of novelty of the computer assisted measuring device 10.

It is to be understood that the present invention is not limited to the embodiment described above, but encompasses any and all embodiments within the scope of the following claims.

I claim:

1. A computer assisted measuring device tied into a computer to generate price quotes or proposals for the carpet cleaning industry comprising:
a measuring wheel, which is used to roll on a surface being measured;
a shaft, which attaches the measuring wheel to the end of the computer assisted measuring device;
a control box casing, which houses computer compartment components and battery compartment components;
a handle for ease of handling;
a computer interface jack and a connection means for connecting the computer assisted measuring device to a computer; and
a software program, which is downloaded onto the computer and generates a sales quote.

2. The device according to claim 1, wherein said measuring wheel utilizes photoelectric technology to determine the distance being measured by the device.

3. The device according to claim 1, wherein said battery component parts include a portable battery.

4. The device according to claim 1, wherein said computer compartment components include a keypad, a LCD display, a reset button, an on and off switch and read only memory.

5. The device according to claim 4, wherein said keyboard is used to enter room code data and command key data.

6. The device according to claim 1, wherein said sales quote includes a customer's name, address, city, state, zip code, phone number, fax number, e-mail address, measurements and cost per square foot factors.

7. The device according to claim 1, wherein said connection means for connecting is a RS 232 cable.

8. The device according to claim 1, wherein said connection means for connecting is an infrared link.
